(19) United States
(12) Patent Application Publication
(10) Pub. No.: US 2009/0150190 A1
(43) Pub. Date: Jun. 11, 2009

(54) PRIVATE SUPPLEMENTAL UNEMPLOYMENT/LAYOFF INSURANCE METHOD AND SYSTEM

(76) Inventors: Lawrence Solomon, New York, NY (US); Uri A. Blackman, New York, NY (US); Urijah A. Kaplan, New York, NY (US); Doug Eckley, New York, NY (US)

Correspondence Address: WOLF GREENFIELD & SACKS, P.C., 600 ATLANTIC AVENUE, BOSTON, MA, 02210-2206, US

(21) Appl. No.: 12/203,105

(22) Filed: Sep. 2, 2008

Related U.S. Application Data
(60) Provisional application No. 60/968,897, filed on Aug. 30, 2007.

(51) Int. Cl. G06Q 40/00

(52) U.S. Cl. 705/4

(57) ABSTRACT

A system and method for computing unemployment insurance premiums that directly supplements government unemployment benefits. To facilitate risk calculations, the work force is classified by industry, occupation, income level, geographic location and many other factors. The insurance premiums are calculated as part of a larger model of private unemployment insurance for high-income workers. If the worker's income exceeds a certain threshold, the insurance would supplement the replacements the government already provides. Additionally this process includes the methods in which the claimant's eligibility is assessed, and how the program is administered (including the claims process). Claim verification relies on piggybacking on the state's determination of a claimant's eligibility for unemployment compensation payments, and the premium computation process takes into account a state's history with respect to granting and denying such claims. The process can also be extrapolated to a non pure supplemental policy.

### CROSS-REFERENCE TO RELATED APPLICATION

This Application claims the benefit under 35 U.S.C. 119(e) of U.S. Provisional Patent Application No. 60/968,897, filed Aug. 30, 2007 in the name of Lawrence Solomon, which application is hereby incorporated by reference in its entirety.

### FIELD OF THE INVENTION

The invention relates to the field of unemployment insurance and, more particularly, to a system and method providing a private supplementation of public unemployment insurance (also know as unemployment compensation), including the automated generation of premiums and issuance of policies.

### BACKGROUND

Unemployment insurance is a benefit currently funded in the United States of America by contributions made by employers (to state and federal governments) on behalf of employees, to protect employees against pure income losses in the event an employee loses his or her job. It is overseen by the federal government but administered by the states. Should a worker be fired or laid off, he or she may receive unemployment benefits in the form of a weekly “replacement” of a portion of his or her salary, for a period of time, provided the job loss was of no fault of the worker. Currently, the federal/state unemployment insurance (UI) program will provide benefits to eligible workers (i.e., those who involuntarily lose their jobs and who are actively looking for work) with supplemental income for a period of up to 26 weeks. This coverage can be extended by the federal government if the unemployment rate in the state is high; in this situation, the federal and state governments share the cost of providing the extended benefits.

Typically, three main criteria have to be satisfied before a worker is eligible for government-sponsored unemployment benefits: the person must have lost his or her job through no fault of his/her own; the person must be ready, willing and able to take on “suitable” new work; and the person must have earned a certain minimum amount of money in the past year. Usually the first four of the last five completed calendar quarters at the time of application is considered the “past year”. Not everyone who loses a job meets these conditions. For example, some people quit their jobs or are disqualified because of misconduct, or their income is too uneven. Therefore, the number of people who qualify for unemployment benefits is substantially smaller than the number of people who are unemployed.

The federal government establishes minimum standards for UI systems, though each state has its own laws and administrative system. The state government typically has to ascertain three things about an unemployed worker seeking benefits, to validate his or her claim. First, whether the worker qualifies for benefits, as discussed in the previous paragraph. Next, the number of weeks of benefits available. This can be shorter than the standard 26 weeks for various reasons, such as the worker's earnings pattern was uneven or her work history was shorter than required for full benefits. Finally, the dollar amount of weekly or monthly benefits must be calculated. For policy reasons, the maximum income supplement usually is a specified fraction of the claimant's pre-unemployment income (hereafter called “original income”), but there also may be an upper limit to supplements; for example, New York State provides a maximum weekly benefit of $405 in 2008. Therefore, for a lower-paid worker, the benefits will reach about 50% of the worker's original income, but for a worker who originally earned a higher salary, the benefits might only reach 25% of his or her original income or some other percentage—perhaps even lower. At current rates, national data indicates UI covers, on average, about 38% of an employee's original income.

Problems with the Current Insurance Model.

To many recipients of benefits, the low coverage percentage and dollar ceilings are serious deficiencies of the current government-mandated unemployment insurance model. Historically, however, unemployment benefits were not meant to substitute for work-based income but instead to “soften the fall” of unemployment, by “replacing” (i.e., supplying) approximately 50% of the worker's original income. That number was thought to be a percentage that would allow the worker to maintain a minimal standard of living and/or to avoid defaulting on his financial obligations, while leaving sufficient incentive for the worker to aggressively search for new employment. As a result of the cap on maximum weekly benefit payments, higher-paid workers (e.g., those at the eightieth or ninetieth percentile) are usually not compensated at anywhere close to the 50% rate. Above a certain original income level, the maximum government compensation limits UI to less than 50% of original income earned by top-paid employees. Moreover, wage inflation in the absence of comparable adjustment of the maximum weekly benefit typically causes, over time, an increasing portion of the claimant pool to be receiving replacement income below the 50% target—i.e., income inadequate to meet their minimal needs for living and avoidance of default on obligations. Yet government-provided unemployment compensation has been observed to fail to keep up with increases in above-median wages, leaving increasing portions of the population at risk of finding UI payments quite inadequate to meet their needs. Further, if the state or federal government proposes to increase employer or employee contributions to unemployment insurance, resistance is often encountered.

While unemployment may happen on an individual basis, it is also true that unemployment may occur to multiple workers of a common employer at a single event, generally called a layoff. A layoff may have the effect of making it more difficult for the individual worker to obtain a new job because of the resulting local increase in unemployment, especially if some of the other laid off workers share job qualifications with the individual UI claimant.

A need thus exists for a private unemployment insurance system and coverage, addressing one or more of the deficiencies of government-administered UI. There is particularly a need for private unemployment insurance that addresses the contingency of a layoff occurring.

Attempts have been made in the past to provide private unemployment insurance, both as a replacement for and as a supplement to government UI. For example, see U.S. patent application Ser. No. 10/729,444 of Suresh Annappindi, titled “Unemployment Risk Score and Private Insurance for Employees.”

However, past attempts have suffered from one or more deficiencies including, but not limited to, use of pricing methods that fail to account for relevant factors including actual claims experience data, cost structures and claims processing criteria and methods that introduce unwarranted expense and delay, and lack of attention to claim severity due to layoffs.

### SUMMARY OF THE INVENTION

A system and method are shown for providing an insurance product, its pricing and administration, which provides to a covered employed worker payments to supplement government UI. A periodic benefit is paid to the policyholder in the event that the insured individual suffers a covered loss of employment. In some embodiments, all loss of employment that is covered by state unemployment benefits is covered after an initial eligibility waiting period. That is, state unemployment eligibility is used as the determinant of benefit eligibility. In this way, an insurer does not have to maintain its own unemployment validation mechanism but can rely on the state agency that determines eligibility.

Individual coverage is shown by way of example, but group insurance is also possible, and could be made available through an employer, as an employment benefit available for purchase. Other delivery mechanisms are also shown.

In some embodiments, the insured contingency may be a layoff of multiple workers by a common employer, rather than simply an individual losing his or herjob.

One aspect of the invention is a method of providing supplemental unemployment insurance. Such method includes issuing to an applicant an insurance policy which, in exchange for premium payments entitled the applicant, when unemployed, to receive a periodic financial benefit for a specified time, provided a state government agency responsible for the administration of unemployment claims verifies the applicant is entitled to receive unemployment insurance benefits from the state; upon receiving from the applicant a claim for unemployment benefits, obtaining from the state government agency confirmation that the applicant is entitled to receive unemployment insurance benefits from the state; and paying to the applicant the financial benefit specified according to the policy.

Obtaining from the state government agency the aforesaid confirmation may be performed by a computer system querying a computer system or database of the state agency, receiving a response to said query, and evaluating said response. Paying the insured may be conditioned on the evaluation of the response indicating the insured/applicant is entitled to a financial benefit.

The financial benefit may be set in the policy to a predetermined portion of the applicant's income when employed, just prior to becoming unemployed, less said applicant's state unemployment insurance benefit. Accordingly, in determining the amounts of the payments to the insured/applicant/claimant, the benefits actually paid by the state are obtained (preferably straight from state computer records) to verify that a proper amount is paid out.

Issuing to an applicant an insurance policy according to this aspect may comprise, via a computer system, receiving from the applicant answers to questions about risk factors used in computing the applicant's eligibility for said supplemental unemployment insurance and, if eligible, an amount of potential financial benefit and a premium therefor; computing said premium if the applicant is eligible; offering to the applicant a policy specifying a potential financial benefit in the event a claim is submitted, unemployment and eligibility for payment are confirmed and premium payments are current; and issuing the policy if the offer is accepted and an initial premium payment is received.

Another aspect is the manner in which a premium is computed. Such computation accounts for a state's history in granting and denying unemployment compensation claims, and various actuarially significant parameters.

### DESCRIPTION OF THE DRAWING FIGURES

In the drawing,

FIG. 1 is a flow chart of an example of a premium calculation as taught herein; and

FIG. 2 is a diagrammatic illustration of a computer network which may be used to practice aspects of the invention.

### DETAILED DESCRIPTION

### Definitions of Insurance Terms

Unless otherwise appears expressly or from context, the following terms have indicated meanings:
Underwriting The process in which a large financial provider assesses the eligibility of customers to receive its products.
Incidence A measure of the unemployment rate. The number of government approved UI claims divided by the total number of U.S. non-farm payrolls.
Moral hazard The possibility that a party insured from risk will behave differently than it would behave if fully exposed to the risk (i.e., uninsured).
Adverse selection Due to information asymmetry, people who subscribe to an insurance policy are those who perceive themselves likely to experience the insured contingency.
Continuance table A table used for insurance premium calculations based on the probability a claim will continue, by time and amount.
Insurance Coverage by contract whereby one party undertakes to indemnify or guarantee another against loss by a specified contingency or peril.
Loss Ratio Ratio of losses paid or accrued by an insurer to premiums earned.

### Insuring Individual Job Loss vs. Layoff

Insurance methods which do not treat individual loss of employment and layoff events as distinct circumstances cause premium calculations to be excessive relative to the risk of individual loss of employment or fail to protect the insurer against the magnitude (i.e., severity) of claims that may result from layoffs. Accordingly it is desirable to price separately coverage for individual job loss risk and layoff risk. Benefits, as well, may be treated separately as an individual may wish to purchase more benefit (either higher payments or payments of longer duration) in the event of a layoff or in the event of his/her singular job loss in a non-layoff situation.

The main reason unemployment insurance is underwritten by the government, and not private industry, is that unemployment insurance, as defined, has not been attractive to a for-profit private insurer. It does not offer to a private insurer many of the characteristics important to a typical insurer when it is deciding whether to underwrite a risk. Generally, the insurance industry desires the following characteristics to be present before it will create an insurance product (policy):
The probability of the insured risk should be reliably predictable for large numbers of insureds, though for one insured the probability of an insured event need not be reliably predictable.
The occurrence of an insured contingency (event) is beyond the insured's control.
The insured contingency, if it occurs, causes a precisely defined or ascertainable monetary loss.
The contingency can be defined precisely and its occurrence, or lack thereof, can be clearly and easily determined.
After the contingency occurs, the amount of monetary loss should be the insured's control.
The incidence of occurrence of the contingency is sufficiently low as to justify the charging of premiums attractive to the potential insureds.
   Put another way, an insurer should be able to calculate with some accuracy both the estimated frequency of claims and their severity, so as to be able to achieve a predictable profit over a sufficiently long interval. Premiums should be affordable. Losses (in this case, the payout on unemployment claims) should be non-catastrophic to the insurer. An insurer should be sufficiently well capitalized that an early heavy claims experience not put the insurer out of business before its long-term profitability can be established. To provide statistics that will justify an insurer risking its capital, claims should be well defined and bounded. That is, those statistics should be such that the potential for many homogeneous exposures to claims is manageable. The insured's loss must be accidental and measurable. From the perspective of an individual insured, one might not be able to measure easily and accurately the loss he or she incurs due to unemployment, but for the insurer, the loss can be made measurable by offering a fixed amount of benefit payable to the individual for a maximum amount of time.

Unemployment may not be entirely outside the employee-policyholder's control, of course. An employee may bring about his or her own termination. Past proponents of private unemployment insurance have thus assumed the need for a claims approval process by which the insurer would take appropriate steps to verify that the claimant's unemployment was not of his or her own creation. This process may require considerable expense and create delay in the claims resolution process. By contrast, as further explained herein, an insurer may take advantage of the fact that the state unemployment administration also must determine that an employee was not at fault in creating the unemployment circumstance. The private insurer can “piggyback” on this determination and avoid duplicative effort if the insurance terms are crafted appropriately to reflect the same criteria as are employed by the state, and to accept the state's determination of eligibility as definitive of eligibility under the private insurance policy. This approach has the advantage that data is available for most states of the rates of approval of unemployment insurance claims, which data can be used to establish a reliable actuarial model from which premiums can be derived and a predictable profit achieved. It has the apparent disadvantage that eligibility criteria differ from state to state and even if two states purport to employ the same criteria, data indicates those criteria may be applied differently. Indeed, over time the criteria of a given state may be applied differently (e.g., a specific criterion may be employed more stringently one year than a few years earlier or later). Hence, it is useful to address and take into account not only the stated criteria for eligibility, but also the statistics indicating how they are applied—e.g., in the form of eligibility approval rates. Heretofore, it appears that such information was not used by providers or proponents of private unemployment insurance, whether supplemental to or place of government-provided UI.

Creating private unemployment insurance requires the addressing of the characteristics listed above. Life insurance, which actually insures against death, is the clearest example of an insurance that meets the foregoing characteristics. When these characteristics are lacking, to write insurance profitably generally requires coercive power. Occasionally, however, even without such power pressing them, insurers are willing to write coverage that meet only some of these characteristics, often imposing conditions and limitations on coverage, or on eligibility. Many types of health insurance fall into this gray area.

Described below is a system and method for establishing and pricing a supplemental unemployment insurance program that will have the characteristics needed for a commercial insurance product that can provide to insureds an additional amount of income benefit on the occurrence of unemployment, over and above the payments received from government UI.

To distinguish the supplemental private unemployment insurance from government UI, we shall refer to it as “PUI,” for short.

With appropriate conditions and payment terms, any eligible cause of termination of employment may be covered, both individual instances of job loss as well as layoffs or reductions in force.

Though an example is not given below, it is contemplated that in some implementations, the insured worker's benefits might differ as between different types of terminations, such as an individual termination or a layoff. A worker might be concerned that mass layoff might make it more difficult to find new employment than an individual loss of position, for example, so that such a worker might wish to purchase different benefits in those two contingencies.

If a layoff is a (or even the only) coverage-triggering or defining event, of course, it will be necessary that the insurance contract define a covered layoff. For example, and without limitation, a layoff might be characterized as there being 50 initial claims for unemployment insurance by an employer's workers within a 5-week period, and that such claimants were separated from their jobs for at least 31 days. (The latter requirement suggests a waiting period, before benefits begin, of perhaps sixty days.) Of course, other characteristics or other numerical values might be adopted.

The underwriting of such insurance is complicated by several challenges. First, there is an inherent information asymmetry between the employees, who know their jobs may be “on thin ice” and the insurers. Thus, the probability of unemployment risk is difficult to calculate globally by an insurer, although individual employees may have a better understanding of their chances. This presents a risk of adverse selection by prospective insureds. Second, and related, unemployment is not necessarily beyond the control of the worker. Fortunately, however, there is already a process in place to decide who is/was at fault for termination. Thus, the insurer can base its approval or disapproval of a claim on the findings of the state agency that administers UI claims. Third, the monetary loss due to unemployment varies for reasons as variable as the workers themselves, and the incidence of unemployment is relatively high; the average worker in the U.S. transitions from one job to another once every five years—not all such situations including an eligible period of unemployment, of course. So good data on potential losses is paramount in the pricing process.

Desirably, the underwriting criteria for a PUI product preferably are designed to meet the goals and address the issues listed above, including to reduce adverse selection and to address the potential “moral hazard”, so-called, of providing a benefit that reduces too much the individual's incentive to seek new employment. For example, the following criteria (or similar), in their entirety or in part may be used for underwriting such insurance successfully:
As a condition for paying a benefit, the insured must qualify for government unemployment benefits, both when the claim is initially requested as well as throughout the duration of the interval in which the claimant collects unemployment benefits payments. (This provides an easy way to verify that a period of involuntary unemployment has commenced and is continuing. A practical implementation is discussed below.)
Impose a waiting period after a policyholder loses his job, before benefits begin. The waiting period might be two weeks, for example. This is done to encourage an insured to begin a job search immediately and thus reduce the moral hazard risk of a laid-off insured not earnestly looking for new employment right away.
Disqualify from eligibility unemployment commencing within a specified interval from the purchase of the coverage (insurance policy or certificate of participation in a group policy). The use of such a waiting or elimination period is intended to discourage a company or its workers from buying PUI based on knowledge that a layoff event is about to transpire. This concern by an insurer is accentuated when the insured contingency is a mass layoff and benefits might have to be paid for dozens or even hundreds of workers. So in the case of layoff coverage, a long elimination period might be imposed, such as 145 or 180 days from purchase, for example, and a shorter period for a non mass layoff coverage.
The employee might be required to be earning a minimum salary, such as $65,000 per year, to qualify for coverage. The salary should be high enough that government unemployment compensation is less, or substantially less than 50% of that salary.
The employee may be requited to work for an employer who meets specified criteria (e.g., as to number of employees, layoff history, history of unemployment claims, etc.).
The unemployment benefit will be based on the salary that the employee had earned during a defined period prior to the loss of employment. The benefit will be a portion of the insured's previous salary, such as 50% minus that which he receives from state unemployment.
The unemployment benefit will not extend beyond either the insured finding new employment or a stated maximum duration following the commencement of payments under the policy, such as a maximum of six months after the termination of employment. This period may be coextensive with state UI benefit payments, or it may be a longer or shorter interval.

As stated above, in some embodiments an individual worker may contract for such insurance directly with an insurer. In some embodiments, an individual worker may purchase such insurance via his/her employer on an individual basis. In some embodiments, a worker may purchase such insurance as a participant in a group insurance plan sponsored by the employer. The insurer may, but need not, impose a possible minimum participation requirement within the company, so that there is sufficient diversification. This purchase of coverage may also be partially subsidized by an employer. Alternatively, in some embodiments, the employer may purchase and pay for the PUI, with the benefit paid to a covered employee, in lieu of, or to supplement, a severance package. This can be restricted to certain classes of employees (management, or salary thresholds) or made available to all employees to ensure the employer does not choose employees that are being selected for a layoff. Hybrid arrangements are also possible, with employer and employee sharing costs.

### Determining the Insurance Premiums

A process is needed for determining premiums in relation to benefits to be provided and the actuarial risk of a claim. Fortunately, a considerable amount of useful data is available in most states. That data can be accessed on an as-needed basis from state government computer systems, or downloaded to a data store operated by an insurer or at least accessible to the insurer.

The basic mathematical structure of most insurance coverage is that claim cost (i.e., payout) is the product of the number of claims expected during the coverage period and the expected average severity of the claims. Premiums can then be set to cover expected claims costs, administrative cost and desired profits. Of course, there is no single number that defines potential claims costs. The actual cost that will be experienced is an unknown. A probability distribution for claims costs is constructed and a number is used in the premium determination that represents a high probability that the actual claims will be a lesser value. Thus, an insurer might use a number representing a 90%, 95% or other confidence level that it exceeds the actual claims that will be received.

For supplemental PUI, the cost structure is somewhat more involved. While the firing of a single employee may be unrelated to the experiences of others, a given layoff event can give rise to a number of claimants. It may thus be desirable to price such insurance in relation to the contingency(ies) insured. Thus, in some embodiments, a premium may comprise a first component related to the expected cost of an individual loss of employment and a second component related to the expected cost of a layoff event, taking into account that it may not be entirely possible to distinguish the two situations. Of course, a PUI policy may cover only a layoff contingency and not an individual job loss, or vice versa. The coverages may be offered separately or bundled together.

For a layoff, the claim cost is the product of (1) the number of insured events (layoff events) expected during the coverage period at employers where coverage is provided to at least one employee, (2) the average number of claimants per event, (3) the average amount of weekly benefit that will be paid to the claimants, and (4) the average duration (i.e., number of weeks) these claimants will qualify for payments.

Claim cost calculations will vary depending on the exact nature of the policy sold, including contingencies insured, weekly benefit, duration of benefits, etc. The weekly benefit depends upon factors such as the percentage of pre-unemployment income being replaced, amount of underlying state UI, etc.

The more involved the policy structure, the more involved the calculations required in setting premium rates. However, with proper statistical analysis it is not a drawback. One statistically significant phenomenon unique to layoff coverage is that claims are coupled, not independent. If one insured gets laid off, chances are that other insureds will be involved in the same layoff event. Thus, loss data will demonstrate a “lumpy” pattern in projected losses, as opposed to a smooth curve. Thus, it is probable that in some years, few claims will be filed, while in other years, many claims will be filed. This lumpiness is enhanced by the cyclical nature of layoff events (discussed later).

This is in contrast to policies such as disability insurance, where each insured has an independent chance of experiencing an insured contingency and making a claim for benefits. However, barring an unusual major disaster (which may be treated via exclusions and benefit reductions), the number of claimants will usually not vary very much from year to year.

The US Department of Labor maintains a statistical database with extensive public information about the United States labor force. Available data include:
number of insured events (layoffs) per year since 1998
average number of claimants per event since 1998
the above information segmented by industry

The Department of Labor considers a layoff to be an incidence of involuntary unemployment of 50 or more workers at a given firm, where the workers become involuntarily unemployed over a period of less than five weeks. Further qualifications include that the workers must be eligible for unemployment insurance, and remain laid off for at least 31 days. Since 98% of full-time employees are covered by unemployment insurance, the Department of Labor database is a reliable estimator of expected layoff patterns for the future for the United States workforce.

Preferably, one or more insurers who commercialize supplemental PUI as defined herein will collect data that will in the future allow for greater segmentation of the marketplace in setting premiums. For example, eventually rates may be refined to account for the size of the employer, as companies of different sizes or in different regions may exhibit different layoff patterns.

Many factors can be used in calculating premiums for a PUI policy. That is, many factors have predictive value in determining the probability of an individual receiving government unemployment benefits (severity) and the length of time he would be receiving those benefits (duration). These factors can be broken down into four categories: Personal, Corporate, Industry, and Economy.

Personal Indicators include, for example, some or all of age, gender, race, income, occupation, credit score, geography, marriage/family status, homeownership, employment (unemployment) history, and education. The Personal Factors all are attributes of the covered person(s).

Corporate indicators are attributes of the insured's employer and include, for example, years in operation, stock price, price to earnings ratio, historical company employment trends, cash flow, revenue and profit changes, and unemployment experience rating.

Industry Data include, for example, unemployment and hiring trends in different industries (e.g., as categorized by the North American Industry Classification System (NAICS)), collected at the State and Federal levels, in major and minor divisions; and indexes that indicate the financial performance of different industrial sectors (e.g., Dow Jones Industry Indexes).

General Macroeconomic Data are attributes of the country's market economy and include, for example, GDP growth rates, unemployment rates, unemployment duration, imports/exports, national debt, and leading and coincident indicators (from the Conference Board).

And as a last step, in some embodiments, data from the state unemployment office may be considered, which would indicate how strict or permissive that state is in accepting claims, both in terms of statutory and regulatory requirements determining the definition of an involuntary layoff in that state, and also in terms of the administrative strictness used in applying the statutory and regulatory standard.

It is not to be expected that buyers of PUI will be a random sampling of the workforce. By virtue of the fact that the employee is buying the coverage for himself, or that her employer is making it available or contributing to its cost, it is likely that his/her actual layoff probability is somewhat different than that of the population at large.

By buying non-mandated insurance coverage, the purchaser is demonstrating a strong sense of risk aversion. This may portend a more stable than average job experience, since such an individual may have optimized his job search towards stability and/or may have planned for his loss of income by lining up another job in advance.

Mitigating against these particular factors are adverse selection probabilities. For example, there is a likelihood that the buyer is acquiring coverage due to knowledge he has of a particular impending layoff or of a financial weakness of his employer that might lead to a layoff. Reducing the probability of adverse selection may be achieved in various ways—including having him warrant in his application that he has no knowledge of any impending layoffs that may affect him, and that he has no reason to believe that his company may be declaring bankruptcy. It is also possible to reduce the probability of the buyer taking advantage of an information asymmetry by instituting a waiting period before coverage is available for covered events after premiums start being paid. The longer this waiting period, the smaller the likelihood of an applicant having any relevant foreknowledge that an insured does not share.

In combining appropriately these variables to come up with a forecast of expected net relative severity and duration of claims, two constraints confront the insurer:

(1) lack of publicly reported available data (e.g., detailed population statistics on how unemployment varies with homeownership); and

(2) near multicollinearity of many variables. (i.e., many of the variables listed above correlate very highly with each other, and are nearly redundant when used together.)

When a model has too many parameters for the information content sought from the data, which in this case is the severity and duration of unemployment claims, it is considered “overfitted.” When the degrees of freedom in parameter selection exceed the information content of the data, this leads to arbitrariness in the final (fitted) model parameters, which reduces or destroys the ability of the model to generalize beyond the fitting data. Thus the best underwriting models are those in which the variables correlate minimally with each other, and maximally with the information sought. When trying to run a regression analysis on an overfitted model, different samples from the same population might give highly varying results—i.e., the model is not statistically robust. However, if enough samples are taken, this tendency will be reduced. Due to the lack of publicly reported available data, though, it is better to start with a few highly independent and dispositive variables, for the most parsimonious correct model (following the Bayesian Information and Minimum Description Length Criterion) and then bring in the rest of the data slowly in a machine learning modeling process when the sampling becomes more robust—i.e., when there is more claims data. He nce, a method will be shown for deriving a premium initially using but a few of the most integral variables, and the model will then be refined using the remaining relevant variables.

To create even a simplified premium model (which can then be eventually bootstrapped up by the introduction of more variables) requires high quality statistics that are used together, ideally those that are measured in an identical fashion, at the same point in time to the extent that is practicable. Data from the relevant state unemployment claims office or from household and business surveys meets this objective. (For example, the federal Bureau of Labor Statistics conducts a Household Survey and an Establishment Survey, respectively, the data from which are readily available.) (Thus, note that premiums should be determined state by state, or even more locally that that if the data supports doing so and localized practices are statistically significant deviations from a state-wide whole. Some Federal data is aggregated and will likely lose important statistical information.)

As a start, two data series will be used that are the most reliable and the least correlated: (1) the industry of the employee's company, and (2) the unemployment and claims approval rate of the state of employment.

In the example under discussion, income level is used to calculate the expected amount of a claim, but not for its influence, if any, on the likelihood of an unemployment event. The two main quantities needed to compute from empirical data is the incidence rate which measure the rate at which workers become unemployed per unit time and the persistency rate which measures the rate at which unemployed workers return to employment per unit time. Additionally, the incidence rate should only include people who qualify for unemployment benefits. For the nation the incidence rate is about 6% per year while the rate at which the unemployed are re-hired is about 4% per week.

### PUI Underwriting

Applicants propose through their system of PUI to ameliorate in part the limitations of the state unemployment insurance model discussed above, extending to a broader market a level of income replacement approaching a nominal 50% (or other desired goal). Government unemployment insurance combined with the supplementation thus provided will replace a certain portion of income (e.g., 50%) in order to make the benefit more meaningful to a broader audience. Variations in coverage could allow for larger or smaller percentages of income to be covered, but the nominal figure of 50% will be used to explain the process here (and not in a limiting sense).

Preferably, the insurer will pay a benefit sufficient to achieve a replacement income level equal the lesser of either: (a) 50% of the equivalent weekly wages reported by the insured at the time of application for insurance coverage, or (b) 50% of the insured's equivalent weekly wages as reported by the State Unemployment Compensation Agency to the insured. The actual payments by the insurer will take into account the sum of benefits received from state unemployment compensation and benefits from any additional unemployment insurance policies. Thus, the insurer will pay only up to the total of government and private payments equaling amount (a) or (b), whichever is less.

These conditions are designed to ensure that the applicant applies for an appropriate amount of coverage, and does not over-insure him/herself, and that irrespective of the potential maximum payments there is an incentive for the policy holder to actively seek new employment.

While an insurer is free to impose additional qualifications, in some embodiments it suffices to simplify the insurer's claim verification process for a policy that has benefits that run concurrently with the state's, by accepting proof of payment of state unemployment benefits to qualify a claim to PUI benefits. The benefit may be payable only after an elimination period of some specified number of consecutive weeks of state unemployment benefits. Typically, increasing the elimination period makes the premium smaller. The benefit may end after regular state benefits run out and the insured is no longer receiving state benefits, or a longer benefit period may be provided. Preferably, claims for unemployment occurring fewer than six months after the initial effective date of the policy will be limited to a refund of premiums paid, in order to reduce the risk to the insurer of the applicant having foreknowledge of an impending layoff. These periods can be changed, with corresponding premium changes to reflect the different adverse selection probability.

### Calculation of Premium Rates

In this section, a sample method for calculating premium rates is provided though not all aspects or embodiments need employ the example method. For each step, a detailed explanation is given of the quantities involved and how they may be extracted from available data. For purposes of this example, example rates for New York State for the year 2008 will be addressed.

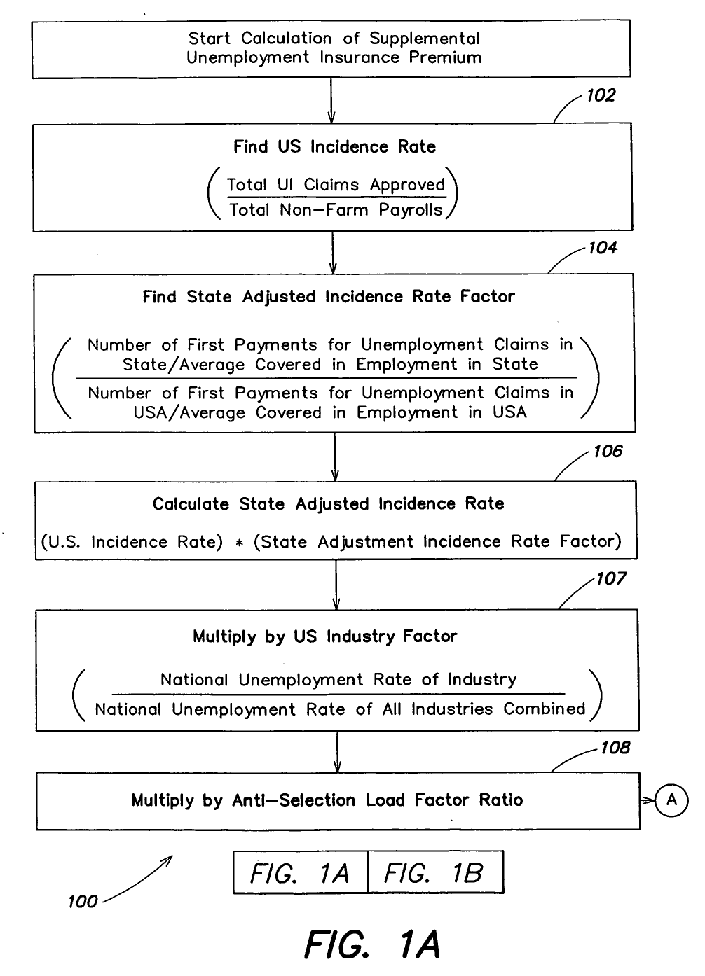

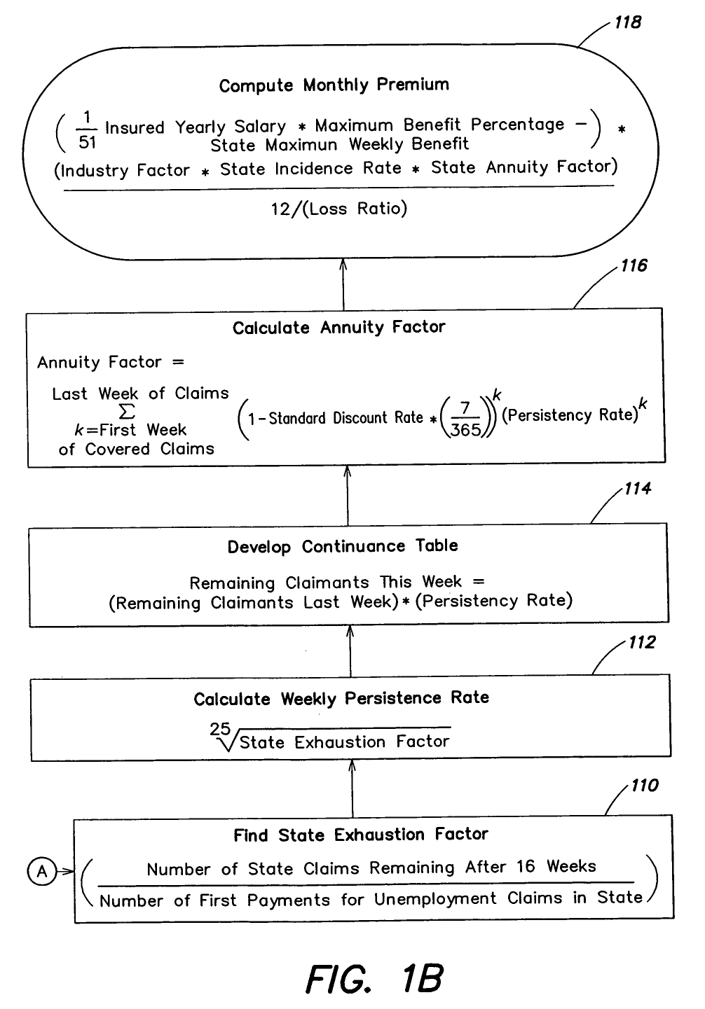

Referring now to FIG. 1, premium computation method 100 begins in step 102 with calculation of the Total US incidence rate of UI claims. The total U.S. incidence rate is defined as the number of government approved UI claims divided by the total number of U.S. non-farm payrolls, obtained from Department of Labor statistics (e.g., for the eighteen-year span from 1990 through 2007). The total number of approved unemployment claims as measured by the Number of First Payments over that period was 149,640,126. The non-farm payroll total over the period was 2,229,228,000. Thus, the annual approved claim rate, i.e., what we are calling the total U.S. incidence rate of UI claims, was 6.7%.

In step 104, starting with the average U.S. Total incidence rate of 6.7%, an adjustment is made to account for state-specific factors and generate a State-Adjusted Incidence rate. The incidence rate adjustment factor for New York in this example is 87.04%. This is found as follows: First, obtain the Number of First Payments (NFP) on unemployment claims in New York in 2007. In this example, NFP=417,686. The average covered employment that year was 8,287,747, for an approved claim rate of 417,686/8,287,747=5.04%. The 2007 Total U.S. number of approved claims was 7,641,942 on an employment base of 131,911,038, for a ratio of 5.79%. The State (i.e., New York) incidence rate adjustment factor is the quotient of these two rates, or 5.04%/5.79%=87.04%. This quotient takes into account the state's unemployment rate, and the strictness of its unemployment benefits approval process. The State-adjusted incidence rate is the U.S. incidence rate times the state adjustment factor. In the example, it is 0.067 times 0.8704=0.05831. Step 106. In step 107, the state-specific incidence rate is adjusted (i.e., multiplied by a factor) to reflect experience in the industry in which the insured works. Some industry factors are shown in Table I, below.

TABLE I

| | |
|---|---|
| All Industries | 100.0% |
| Agriculture, forestry, hunting | 106.7% |
| Mining | 76.2% |
| Construction | 137.4% |
| Manufacturing | 101.9% |
| Durable goods | 93.3% |
| Nondurable goods | 117.3% |
| Wholesale and retail trade | 116.4% |
| Transportation and utilities | 81.3% |
| Information | 87.2% |
| Financial activities | 61.4% |
| Professional and bus services | 121.6% |
| Education and health services | 63.9% |
| Leisure and hospitality | 175.6% |
| Other services | 98.6% |
| Public administration | 36.8% |

(Source: U.S. Statistical Abstract, 2007; Unemployment rates by industry divided by All Industries Combined.)

Optionally, in step 108, an anti-selection load factor is applied to the state and industry-adjusted incidence rate. This allows for the fact that people who purchase the coverage may tend to have a higher frequency of claims than those who decline the coverage as they might have foreknowledge of potential unemployment. However, it is anticipated that the underwriting that is performed at the time of application, as well as the waiting period for benefit eligibility, will offset any substantial anti-selection activity. Therefore, for this example, no anti-selection load factor was used in deriving the New York premium rates.

Other useful factors include the average number of weeks an eligible claimant receives benefits. This can be estimated from the fact that the average duration of unemployment claims in 2006 (the most recent year for which complete data is available as of this filing) was 15.2 weeks. Along with the rate of claim approval and the number of people unemployed each year, this information can be used to estimate the total number of weeks of unemployment collected by all workers in a given year.

Of course, the dynamics are also important. Not all of those claimants would draw benefits at the same time, and averages do not reveal the cash flow demands created by unemployment claims. For use in developing the dynamic picture, in step 110, an “exhaustion rate” is determined. The exhaustion rate is the percentage or fraction of benefit claimants who receive benefits for the full duration of the benefit period. In the absence of more precise data, one may assume a constant percentage of claimants terminate their benefits each week—either because they are re-employed or because benefits have been exhausted. The percentage of claimants terminating each week is a multiplier that will produce the percentage of claimants who reach the end of their benefit period while still receiving benefits. Using this datum, a geometric distribution (or other appropriate distribution) is constructed, defining as a function of time the number of people who have been unemployed for k weeks.

A weekly persistence rate is calculated in step 112, as follows: In New York, the 17-year average of the percentage of claimants reaching the end of the 26-week benefits period is 0.469. This rate is fairly consistent in recent years. The weekly claim persistency rate would naturally accumulate to the survivorship of benefits at the end of the 25th week. The 25th root of 0.469 is 0.9702. Therefore, the New York weekly persistency rate is 97.02%. That is, the weekly persistency rate indicates the rate at which claimants one week proceed to being claimants the next week.

Optionally, it may be desirable to adjust the weekly persistence numbers to take into account so-called “moral hazard” concerns. A moral hazard adjustment reflects that people may tend to change their behavior after they have purchased the lay-off insurance coverage and anticipate payment of benefits. In other words, PUI may somewhat reduce the incentive for UI benefit recipients to find new work. For example, if the moral hazard adjustment is two weeks, for the first two weeks after the claim is incurred a persistency rate of 100% may be assumed.

Using the persistency rate calculations, a continuance table may be generated. Step 114. The continuance table is a schedule of the fraction of claimants that will remain receiving benefits, week by week, given that a claim was incurred in the first week. The formula used in developing such a table is:

[remaining claimants this week]=[remaining claimants last week]*[persistency rate].

The continuance table is then discounted in Step 116. The continuance table may be discounted using an interest rate to obtain annuity factors corresponding to a claim that has been outstanding for any particular number of weeks. A 5% (or other applicable) annual interest rate may be used as a discount rate and summed to develop an unemployed annuity factor, Step 118. For the 24-week benefit in New York in this example (after a two-week non-payment interval for moral hazard protection), the unemployed annuity factor is 16.599936. The weekly example calculation is below:

$$[ annuity ] = {\sum }_{k = 3}^{26} {( 1 - 0.05 * ( 7 / 365 ) )}^{k} {( 0.9702 )}^{k}$$

Table II below charts an example continuance table using such a 5% annual discount rate (0.000938713 weekly) and a weekly claim termination rate of 0.97019226, which above was rounded to 0.9702.

TABLE II

| Week of | | Interest | Persistency × |
|---|---|---|---|
| Unemployment | Persistency | Factor | Interest Factor |
| 3 | 0.970192257 | 0.997189141 | 0.967465183 |
| 4 | 0.941273016 | 0.996253944 | 0.937746955 |
| 5 | 0.913215793 | 0.995319625 | 0.908941600 |
| 6 | 0.885994891 | 0.994386182 | 0.881021077 |
| 7 | 0.859585384 | 0.993453615 | 0.853958207 |
| 8 | 0.833963084 | 0.992521922 | 0.827726643 |
| 9 | 0.809104527 | 0.991591103 | 0.802300850 |
| 10 | 0.784986947 | 0.990661157 | 0.777656077 |
| 11 | 0.761588258 | 0.989732082 | 0.753768333 |
| 12 | 0.738887032 | 0.98880388 | 0.730614364 |
| 13 | 0.716862477 | 0.987876547 | 0.708171629 |
| 14 | 0.695494425 | 0.986950085 | 0.686418282 |
| 15 | 0.674763306 | 0.986024491 | 0.665333146 |
| 16 | 0.654650135 | 0.985099765 | 0.644895695 |
| 17 | 0.635136493 | 0.984175907 | 0.625086034 |
| 18 | 0.616204507 | 0.983252915 | 0.605884878 |
| 19 | 0.597836842 | 0.982330789 | 0.587273537 |
| 20 | 0.580016675 | 0.981409527 | 0.569233891 |
| 21 | 0.562727688 | 0.980489129 | 0.551748381 |
| 22 | 0.545954046 | 0.979569595 | 0.534799983 |
| 23 | 0.529680388 | 0.978650923 | 0.518372200 |
| 24 | 0.513891811 | 0.977733112 | 0.502449040 |
| 25 | 0.498573856 | 0.976816163 | 0.487015001 |
| 26 | 0.483712495 | 0.975900073 | 0.472055059 |
| Total | | | 16.59993604 |

For each state in which such PUI is offered, the applicable maximum unemployment weekly benefit should be determined from generally available sources. Using the weekly benefit, it is possible to determine the benefit that will be paid to a claimant, based on the amount of income replacement purchased. The New York maximum weekly benefit at the time this is written, for example, is $405.00. So, the weekly benefit from the insurer is 50% of covered wages, less $405.00.

Using the above information, a premium may be computed, Step 120.

Gross premiums may be calculated for each individual at the time of application, preferably by a computer program. A sample rate calculation for an applicant is provided below.

Base premium rates may be adjusted periodically to reflect changes in the rate of unemployment incidence.

### Example Calculations

It may be helpful to now consider some realistic examples of situations and to illustrate how premiums may be calculated using the methodology taught herein.

### Generic Calculation of Premium

Case 1

Consider an applicant who is paid a salary of $80,000 per year, lives in New York and works in the Education and Health Services industry in New York. Under normal state UI rules, clearly this worker would receive the maximum benefit of $405.00 per month.

The Education and Health Services industry sector may be found by reference to available labor statistics to have a substantially lower unemployment rate than the national average. Assume the industry adjustment for this worker is a discount factor of 0.639. The state incidence is 0.5831 and the state annuity factor is 16.60, as computed earlier.

The weekly maximum benefit is half of the worker's normal weekly wages:

$80,000/(52*2)=$769.23

The PUI provides for benefits beyond that which the government provides, up to the coverage limit of

$769.23−$405.00=$364.23 per week

The annual claim cost to the insurer is:

$364.23*0.639*0.05831*16.60=$225.28

This is the cost to the insurer to cover the expected amount of benefits.

The basic monthly premium (adjusting for the loss ratio) is therefore

$225.28/(12*0.49)=$38.31.

This basic monthly premium then should be adjusted to account for a waiver of premium payments when the worker claims unemployment, so the adjusted monthly premium it is $39.30.

### Separating Effects of Demographic Factors

More precision in premium setting can be achieved if it is possible to construct a worker's expected unemployment rate by using components based on demographic factors. In order to more accurately assess the risk of unemployment for an applicant, it would be useful to know his state's and/or industry's contribution to his chances of being unemployed in the future. The basic process presented above simply multiplies “adjustment factors” corresponding to the state, industry, etc. However, one might try to consider more sophisticated approaches.

However, apparently there is no database of unemployment data with a level of detail much different from the Bureau of Labor Statistics reports. There are unemployment rates by type of occupation, industry, gender and state, and other demographic variables. However, greater precision requires unemployment rates which consider all these (and/or other) factors simultaneously. In probability theory it is known that a joint probability distribution cannot be determined uniquely from its marginal distributions. In other words, it is impossible to infer from the data available, any more detailed version of the unemployment rates. Therefore estimates must be based on data which is available from the Bureau of Labor Statistics. A simple geometric approach to that data is proposed here.

Consider three industries: education (Edu), construction (Const) and management (Mgmt), and two states: New York and Texas. Therefore the total combination of industry versus state looks like:

{Edu,Const,Mgmt}×{NY,TX}

Based on prior knowledge of the distributions, a random applicant would be Edu ¼ of the time, Const ⅓ of the time and Mgmt 5/12 of the time. He is also NY 3/7 of the time and TX the rest of the time. The total probability matrix looks like:

| | Edu | Const | Mgmt |
|---|---|---|---|
| NY | A | C | E |
| TX | B | D | F |

Computing the individual probabilities a matrix of four equations in six unknowns results:

$$( \begin{matrix}1 & 1 & 0 & 0 & 0 & 0 \\ 0 & 0 & 1 & 1 & 0 & 0 \\ 1 & 0 & 1 & 0 & 1 & 0 \\ 1 & 1 & 1 & 1 & 1 & 1\end{matrix} ) ( \begin{matrix}A \\ B \\ C \\ D \\ E \\ F\end{matrix} ) = ( \begin{matrix}1 / 4 \\ 1 / 3 \\ 3 / 7 \\ 1\end{matrix} )$$

If this set of equations is row-reduced (e.g., using a computer) the following simpler system results:

$$( \begin{matrix}1 & 0 & 0 & - 1 & 0 & - 1 \\ 0 & 1 & 0 & 1 & 0 & 1 \\ 0 & 0 & 1 & 1 & 0 & 0 \\ 0 & 0 & 0 & 0 & 1 & 1\end{matrix} ) ( \begin{matrix}A \\ B \\ C \\ D \\ E \\ F\end{matrix} ) = ( \begin{matrix}- 9 / 28 \\ 4 / 7 \\ 1 / 3 \\ 5 / 12\end{matrix} )$$

This means there are two degrees of freedom: D and F and the constraints are as follows:

$$4 / 7 \geq D + F \geq 9 / 28$$

$$1 / 3 \geq D \geq 0$$

$$5 / 12 \geq F \geq 0$$

This is a hexagon in the D, F plane whose centroid can be computed. Using a good estimate for (D, F), an estimate can be computed for all 6 probabilities. The resulting value of (D, F) is (0.18, 0.25) and the probability distribution is summarized in Tables III and IV:

| TABLE III | | | | | TABLE IV | | | |
|---|---|---|---|---|---|---|---|---|
| | Edu | Const | Mgmt | | | Edu | Const | Mgmt |
| NY | 0.112 | 0.148 | 0.168 | vs. | NY | 0.107 | 0.143 | 0.179 |
| TX | 0.138 | 0.185 | 0.249 | | TX | 0.143 | 0.190 | 0.238 |

Table III is the distribution if it is assumed the individual variables are not correlated. Some assumptions regarding correlation of the variables is made in generating Table IV. The difference in the two probability calculations between tables III and IV (correlated and uncorrelated), comparing the same probabilities, is on the order of 0.5% which is significant.

While other computational approaches might be used to determine premiums in the absence of detailed data sets, this approach appears to be reasonable based on available data.

Premium Waiver and Cost

Typically, premiums may be waived during a period of unemployment. The additional cost thus represents to an insurer can be calculated based on a baseline claim cost. The waiver cost may be calculated as the ratio of the baseline gross premium to the benefit cost. The claim cost per $1.00 of weekly benefit (CCWB) is equal to

$$CCWB = \frac{[ incidence rate ] * [ annuity factor ]}{52 * [ target loss ratio ]}$$

In this context, the loss ratio functions like a profit margin. Assume for purposes of illustration a loss ratio of 49%.

$$In New York , the CCWB thus may be calculated as \frac{0.067 * 0.8704 * [ industry factor ] * [ 16.599936 ] = 0.0380}{52 * .49}$$

Therefore, the monthly premium may be divided by a factor of

1/(1−(3.80%*[industry factor]))

to reflect the cost of waiving premiums in addition to payment of claims.

Since premiums are payable on a monthly basis, no active life or unearned premium reserves need be held.

Since the claim cost was calculated on a present value basis using the 5% interest assumption, and there are no active life reserves, no additional consideration need be given to investment income in the premium rate derivation.

Layoffs

One statistically significant phenomenon unique to this insurance policy is that the claims experiences of insureds may not be independent of one another. If one insured is laid off, there may be other insureds working for the same employer who will be involved in the same layoff event. As stated above, it is advisable to determine a premium for layoff coverage different from that for individual job loss. A model used for layoff PUI premiums should, if possible, take into account factors for the employer's history, the size of the employer's workforce, the relevant industry, etc.

### Extrapolation to a Non-Pure Supplemental Policy

At a simplest level, pricing a premium for more than the typical 26 weeks of state unemployment coverage would simply consist of varying the value of k, the benefit period, to be larger than 26. However, one also may adjust the persistency function, such as to make a discontinuity at the 26 week mark, by comparing the number of claimants reaching the end of week 26, to the number reaching an extended interval of, say, the end of week 39. However, periods when Extended (i.e., 39-week) Benefits are in Effect are also periods when the unemployment rate is unusually high, which is correlated with a longer duration of unemployment. That effect can be mitigated by comparing the 26 week unemployment rate during Extended Benefits Periods. Thus, an adjustment can be made by multiplying the 39 week Extended Benefit persistency rates by the ratio of 26-week persistency rates for regular and extended benefits periods. For example, that ratio might be

$$\frac{{Pers}_{26 Reg}}{{Pers}_{26 Ext}} = \frac{.9702}{.9803} = 98.97 \% , to use typical numbers .$$

### A More Sophisticated Model for Finding a Unemployment Persistency Function

By looking at the number of first claims and first benefits each week, the number of people receiving benefits each week, the number of people exhausting benefits each week, and the size of the workforce each week (all easily available data), it is possible to model the “flow” of employment on a weekly basis. Such a model gives a more accurate week-to-week picture of the rate at which claimants stop collecting benefits each week. This model also informs the differential equations governing unemployment by supplying valid constants, and provides a more powerful framework for calculating how the duration of benefits is affected by different variables.

### Summary of the Application Process

An application process can assume many forms and must take into account whether an individual policy is being sold, an employer-sponsored policy, one that covers layoffs (or not), etc. Thus, no single process best fits all situations. In general, however, it may be desired, for purposes of efficiency, to employ an on-line application process insofar as is practical.

For example, for sales of individual policies which do not cover layoff events, and only individual job loss, appropriate applications software programs executing on an insurer's server (or a server to which the insurer has access, in any event), may present to an applicant a series of screens (i.e., pages) containing information requests, receive responses from the applicant, verify certain information, calculate a premium and policy coverage, and make an offer of a policy, if the applicant is eligible. Then, upon collecting a premium, such as by the applicant authorizing a charge to a credit card, the server may issue a policy, record the particulars, and deliver a printable version to the applicant.

Elsewhere herein, suitable questions/information requests are discussed.

Information that the insurer desires to verify before issuing a policy often can be checked by operating the server to electronically access databases (public and private) that contain suitable data, such as address directories and telephone directories, business records of the state government, and so forth. In some instances, information may have to be requested by other means such as e-mail or even the placement of a phone call, so it may be necessary to delay policy issuance until all requisite information has been obtained or confirmed.

### Collecting Data

Over time, in addition to using data available from state and federal government records and reports, additional data may be collected as a result of an insurer developing a history of experience with such PUI policies. Or additional sources may be found. All of such data may be used to refine the calculation of premiums by adding risk factors into the calculations or refining the values used for risk factors, or replacing risk factor numbers with functions from which values may be computed. Such data may include some or all of the following, for example:
Employment history: Employees with stable work histories are least likely to get laid off in the future. Thus, a worker with a volatile employment history may be charged a higher premium than someone who has spent a long time at each job. Premiums might be adjusted depending on the average tenure the employee held past positions.
Current Salary: Certain salary ranges may be excluded or subject to additional adjustments. For example, employees making less than $65,000 per year may exhibit higher moral hazard risk in the event of a layoff. Correlating salary with claims experience over time may allow an insurer to develop salary-based premium adjustments.
Current employer: Some employers might be particularly risky or safe institutions. For example, impending bankruptcy proceedings at an employer might result in its employees being temporarily ineligible for signing up for coverage. A database could be maintained of news events for major employers, for example, and a rating assigned to such employers based on relevant information.
Current industry: Different industries exhibit different layoff patterns. A person working in education might face much lower risk of job loss than someone working in the financial services industries, all other variables held constant. As noted above, an industry factor can be invoked to reflect these differences. Privately collecting data may yield better or more relevant information than BLS reports above.
Job Function: Certain job functions may exhibit distinct susceptibility to layoff events. For example, secretaries may be less likely to be laid off than investment banking associates, all other variables held constant. In other words, even within the same industry, occupational factors may lead to differences in incidence rates. With reliable data gathering, a job function adjustment may be applied in premium calculation.

In order to collect data about PUI applicants, any suitable form of data collection may be employed. One desirable approach is to provide via an Internet web server, a web form which can be completed by an applicant, to collect desired information. The data collection process may be organized into several stages.

For example, on a first page, standard basic information may be collected such as: name, address, telephone number, age, e-mail address and social security number. Preferably, processes are executed by the system to verify all this information. If any information is inconsistent with existing sources, a flag may be set to start a process to resolve the inconsistency.

On another page, basic information may be collected about the applicant's employer, such as its name, address, industry, telephone number and federal employer tax ID number. The name, address and industry preferably are checked against a database (such as Ward's Business Directory of U.S. Private and Public Companies) to make sure they exist and are in agreement. If all of this information is complete, the applicant may be asked for a more detailed description of his company and his job description.

As many pages may be presented as necessary to gather all of the information the insurer desires, such as, but not limited to, company size, length of employment so far, previous employment, the employee's history with respect to collecting unemployment compensation, his financial history and other relevant factors. This information will be used to check for adverse selection risks on part of the employee. If the applicant does not meet certain criteria, he may be notified that the insurer will not offer a policy.

Thus, the application form for a policy may be a several page questionnaire whose results will be processed by a server-side script program that will calculate a premium in accordance with the provided data after verifying the information, and applying the insurer's underwriting guidelines.

### Example Implementation

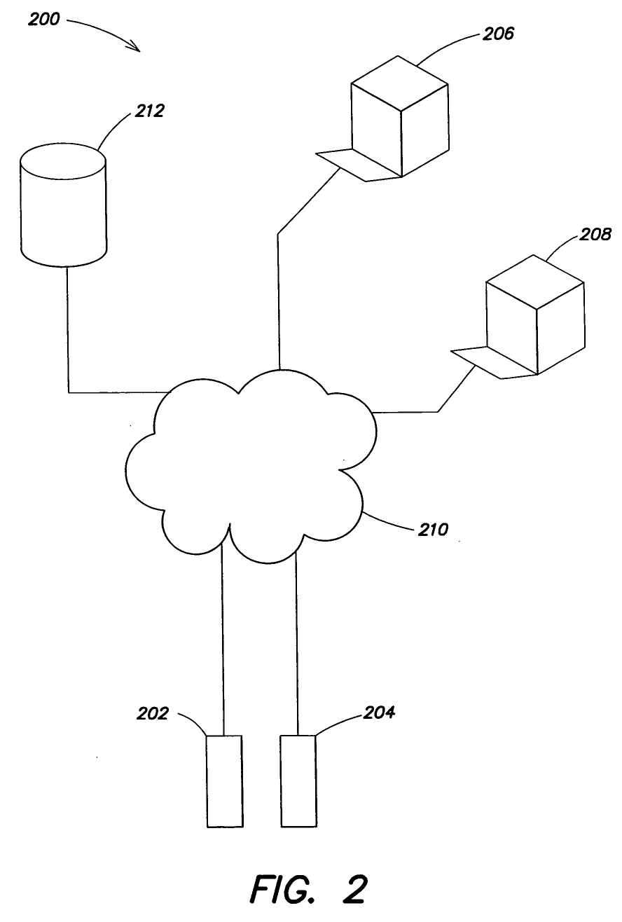

The method described above can be practiced in various ways. However, FIG. 2 shows an example of a computer system configured for this purpose. The system 200 comprises one or more servers 202, 204, one or more remote terminal devices 206, 208 and a data communications network 210 to allow them to intercommunicate. The data communications network may comprise any suitable communications network such as, but not limited to, the global internet, an organizational intranet, a wireless network, or some combination of the foregoing. The example will principally rely on the network being the global internet. At least one of the servers 202, 204 may be a web server that delivers up web pages (formatted, e.g., in a version of HTML or XHTML or another markup language) in response to input from one of the terminals 206, 208 (which may be any kind of data communications devices), and a server (let's say 202) or other computer which executes one or more computer programs that operate as described herein to (a) issue a policy and/or (b) process an unemployment claim. System 200 preferably includes one or more databases 212. The databases may be localized or distributed and stored in the storage medium of a server or elsewhere. One or more of the databases may be maintained by a state government or federal government agency. Server 202 delivers through an internet connection to a terminal 206, for example, website pages generated by the application software and viewed on, for example, internet browser software at terminal 206. The remote terminal may interact with the server, through a standardized communications protocol such as the HTTP protocol, to allow a server to request information and supply output or, conversely, a user to supply input and receive output.

On one or more pages delivered up by the server and appearing in the user's browser, a request for input data will be presented and input data will be received. Such data may include, for example, the name and address of the insurance applicant, his or her telephone number, age, e-mail address and social security number; employer information such as employer name, address and telephone number, the employer's industry and the applicant's occupation. In the case of the industry and occupation information, it may desirable to first obtain general information and then more specific information dependant upon the general information. For example, pull down menus may be used to allow selection of a general industry category and once the entry on that menu has been selected, a sub-menu may be provided in which there is a further pull down list.

Certain of the input data preferably will be verified against commercially or generally available databases, such as, for example, to confirm the employer name, address, industry and telephone number. The server may check for blank or incomplete responses and prompt the user to supply requested information.

In some embodiments, one or more pages may be presented to solicit information of the type discussed above, to permit an underwriting analysis to be performed and a premium to be generated, if coverage criteria are met. A typical list of questions and data requests, for example, might be as follows:
i. Does your company consist of at least 50 employees? Y/N checkboxes
ii. How many months have you worked there? (Small text box to fill in number between 0 and 600)
iii. What are your previous year's wages?
iv. Do you know that you will become unemployed or have any reason to believe that you may become unemployed? Y/N checkboxes
v. Have you been involuntarily unemployed or collected state unemployment insurance benefits in the last 3 years? Y/N checkboxes
vi. Are you in a casual, temporary or seasonal employment (including casual, temporary or seasonal contracts) or in any type of occupation where unemployment is a regular feature of that particular job? Y/N checkboxes
vii. Do you or a close relative own more than 10% of your employer? Y/N
viii. Are you a Contract Worker and Employed under a fixed term contract of Employment (i.e. you receive 1099 and not a W2), or the expiry of an apprenticeship or training contract? Y/N checkboxes
ix. Have you been convicted of a fraud related felony crime in the past 10 years? Y/N checkboxes, if Y is checked a text box will open underneath, headed by “If yes to the above question, please explain here.”
x. Are you aware of your employer being involved in any bankruptcy proceedings? Y/N checkboxes.
   The input data may be tested against predetermined criteria and in some events, the applicant may be declined insurance. Some answers may prompt further questions or human intervention. As examples, for iii) if the answer is below some threshold dollar amount, a page may display, saying that the applicant is not qualified for the policy at this time. Other disqualifications might be a negative answer to iv), an affirmative answer to v)-viii) or x). Further, an insurer might not offer this insurance to a worker in a company of fewer than 50 (or some other number of) employees.

If no flags were raised, then the server may proceed automatically to generate a premium offer. If no flags were raised, signifying a need for more information or human attention, a premium is generated, then an offer may be sent to the user's remote terminal from the server, indicating the premium and providing an opportunity for the worker to accept the policy. Further screens may manage the payment process, such as a charge to a credit card account.

### The Claims Process

One of the advantageous repercussions of setting the claims period of the product to only be in force concurrently with the state's established program, is the ease of verifying claims. By “piggybacking” on top of the state's existing unemployment verification process, claims verification becomes merely payment verification (i.e., instead of having a claims adjuster look over paperwork proving a layoff, and checking in every payment period to see if the laid-off worker has a new job yet, the state can do that work for the insurer, and the insurer just has to verify that the state has authorized a weekly or bi-weekly payment to the insured). This is only possible in a pure supplement policy, where the conditions for payments match those of the state.

If a state agency will grant a private insurer access to its claims verification or payment data, then it is possible for the policyholder to make a claim on-line and for software to query the state database for verification of the claim, and to authorize payment to the insured. The data required from the state is not just a yes/no determination, but the amount of benefit being paid to the worker. This is needed to compute the supplemental benefit the worker is owed.

Verification, in some embodiments, may have two stages, and can be done in several ways.

Stage 1
The notice from the state is received by the insurer, with a determination of benefits. This puts the insurer on notice for an impending claim.

Stage 2
A ledger of all payments from the state is kept, in order to accurately supplement the proper payments, since there is a waiting period of some weeks from the first unemployment benefit. Sufficient proof of payment could be:
1. The original or copy of the periodic check sent to the claimant, or
2. The original or copy of a bank statement, if it was a direct deposit, or
3. Electronic payment status from state records.

Payments can be made in any acceptable form, such as direct deposit in a bank account, or to state funded debit account.

### Cyclicality

Unemployment insurance claim experience will be subject to macroeconomic forces. During an improving business climate, at the top of the business cycle, and perhaps partway into a downturn, the number of layoffs each week will decrease. During slowdowns, at the bottom of the business cycle, and perhaps partway into the upturn, unemployment insurance claims will increase each week. This will lead to similar trends for the rate at which people apply for the extended unemployment benefits we provide. In improving sections of the economic cycle, business should be slower than during recessions when workers will immediately sense the need for insurance benefits.

For unemployment insurance, other economic forces will likely oppose the ebb and flow of the economic cycle. Prospective applicants will be less likely to purchase insurance at the times they need it most. At times of economic stability, the prospect of a layoff will receive little attention. Insureds will be more likely to buy when they need it least, at the bottom of the cycle. During times of economic instability, when the prospect of a layoff seems highest, in actuality, most of the layoffs have already occurred. The “backwards” nature of demand for unemployment insurance stems from the inherent long term nature of jobs tenures and unemployment lengths.

In other words, unemployment insurance should be more profitable during times of economic instability. This should be attractive to insurers who, by offering a proper mix of coverage, including unemployment insurance, may be able to diversify its portfolio of coverage. This should lead to more consistent premium revenues when viewed over the course of a business cycle being more profitable in a broader range of times.

Furthermore, a statistical analysis of Department of Labor data covering the period 1998 through 2002 shows that cyclicality may not be as extreme as many might believe. It was found that peak claim rates were less than 1.5 times claim rates at the trough.

### Example Data used in Above Illustrations

TABLE A
18-Year Average Incidence Rate - US Total

| | | Non-Farm | |
|---|---|---|---|
| | | Payrolls | Approved |
| Year | Incidence | (000) | Claims |
| 1990 | 7.9% | 109,487 | 8,628,557 |
| 1991 | 9.3% | 108,374 | 10,074,550 |
| 1992 | 8.5% | 108,726 | 9,243,338 |
| 1993 | 7.1% | 110,844 | 7,884,326 |
| 1994 | 7.0% | 114,291 | 7,959,281 |
| 1995 | 6.9% | 117,298 | 8,035,229 |
| 1996 | 6.7% | 119,708 | 7,989,615 |
| 1997 | 6.0% | 122,776 | 7,325,279 |
| 1998 | 5.8% | 125,930 | 7,331,890 |
| 1999 | 5.4% | 128,993 | 6,951,210 |
| 2000 | 5.3% | 131,785 | 7,033,133 |
| 2001 | 7.5% | 131,826 | 9,877,448 |
| 2002 | 7.7% | 130,341 | 10,092,569 |
| 2003 | 7.6% | 129,999 | 9,935,108 |
| 2004 | 6.4% | 131,435 | 8,368,623 |
| 2005 | 5.9% | 133,703 | 7,917,294 |
| 2006 | 5.4% | 136,086 | 7,350,734 |
| 2007 | 5.6% | 137,626 | 7,641,942 |
| 18-yr | 6.7% | 2,229,228 | 149,640,126 |
| Avg | | | |

Source: U.S. Department of Labor ftp://ftp.bls.gov/pub/suppl/empsit.compaes.txt and U.S. Department of Labor ET Financial Handbook 394

TABLE B
Derivation of New York Modification to US Incidence Rate

| | | First | | Relative |
|---|---|---|---|---|
| | Average | Benefit | Approved | Approved |
| | Employment | Payments | Claim Rate | Claim Rate |
| New York | 8,287,747 | 417,686 | 5.04% | 87.04% |
| United States | 131,911,038 | 7,641,942 | 5.79% | 100.00% |

Source: U.S. Department of Labor ET Financial Handbook 394

TABLE C
Industry Factors

| | |
|---|---|
| All Industries | 100.0% |
| Agriculture, forestry, hunting | 106.7% |
| Mining | 76.2% |
| Construction | 137.4% |
| Manufacturing | 101.9% |
| Durable goods | 93.3% |
| Nondurable goods | 117.3% |
| Wholesale and retail trade | 116.4% |
| Transportation and utilities | 81.3% |
| Information | 87.2% |
| Financial activities | 61.4% |
| Professional and bus services | 121.6% |
| Education and health services | 63.9% |
| Leisure and hospitality | 175.6% |
| Other services | 98.6% |
| Public administration | 36.8% |

Source: U.S. Statistical Abstract, 2007; Unemployment rates by industry divided by All Industries Combined

TABLE D
Data Supporting Derivation of Weekly Termination Factor

| | | Number of | | Number - | |
|---|---|---|---|---|---|
| | | Approved | Claim | Full | Percentage - |
| State | Year | Claims | Weeks | Duration | Full Duration |
| New York | 1990 | 615,228 | 10,963,669 | 216,735 | 36.5 |
| New York | 1991 | 737,436 | 14,767,637 | 329,288 | 46.3 |
| New York | 1992 | 673,398 | 14,203,249 | 365,156 | 51.5 |
| New York | 1993 | 556,420 | 11,500,436 | 289,269 | 49.7 |
| New York | 1994 | 581,477 | 11,576,839 | 262,085 | 45.0 |
| New York | 1995 | 582,840 | 11,490,012 | 247,234 | 42.6 |
| New York | 1996 | 541,784 | 10,414,170 | 263,380 | 46.8 |
| New York | 1997 | 490,304 | 8,929,143 | 250,841 | 48.6 |
| New York | 1998 | 471,413 | 8,007,544 | 228,307 | 48.9 |
| New York | 1999 | 416,634 | 7,391,718 | 209,016 | 45.5 |
| New York | 2000 | 424,234 | 6,805,690 | 186,345 | 46.3 |
| New York | 2001 | 624,207 | 9,804,063 | 245,313 | 50.0 |
| New York | 2002 | 618,022 | 11,736,255 | 382,783 | 57.9 |
| New York | 2003 | 599,055 | 11,172,218 | 364,275 | 58.4 |
| New York | 2004 | 513,350 | 9,483,680 | 257,891 | 47.4 |
| New York | 2005 | 488,443 | 8,777,875 | 192,197 | 38.7 |
| New York | 2006 | 454,201 | 8,117,589 | 177,109 | 37.7 |
| Average | | | | | 46.9 |

Source: U.S. Department of Labor ET Financial Handbook 394

TABLE E
Unemployed Continuance and Annuity Calculation
State of New York

| Termination | Discount | Weekly |
|---|---|---|
| Rate | Rate | Discount |
| 0.97019226 | 5.00% | 0.000938713 |

| Week of | | | Persistency × |
|---|---|---|---|
| Unemployment | Persistency | Interest | Interest Factor |
| 3 | 0.970192257 | 0.997189141 | 0.967465183 |
| 4 | 0.941273016 | 0.996253944 | 0.937746955 |
| 5 | 0.913215793 | 0.995319625 | 0.908941600 |
| 6 | 0.885994891 | 0.994386182 | 0.881021077 |
| 7 | 0.859585384 | 0.993453615 | 0.853958207 |
| 8 | 0.833963084 | 0.992521922 | 0.827726643 |
| 9 | 0.809104527 | 0.991591103 | 0.802300850 |
| 10 | 0.784986947 | 0.990661157 | 0.777656077 |
| 11 | 0.761588258 | 0.989732082 | 0.753768333 |
| 12 | 0.738887032 | 0.98880388 | 0.730614364 |
| 13 | 0.716862477 | 0.987876547 | 0.708171629 |
| 14 | 0.695494425 | 0.986950085 | 0.686418282 |
| 15 | 0.674763306 | 0.986024491 | 0.665333146 |
| 16 | 0.654650135 | 0.985099765 | 0.644895695 |
| 17 | 0.635136493 | 0.984175907 | 0.625086034 |
| 18 | 0.616204507 | 0.983252915 | 0.605884878 |
| 19 | 0.597836842 | 0.982330789 | 0.587273537 |
| 20 | 0.580016675 | 0.981409527 | 0.569233891 |
| 21 | 0.562727688 | 0.980489129 | 0.551748381 |
| 22 | 0.545954046 | 0.979569595 | 0.534799983 |
| 23 | 0.529680388 | 0.978650923 | 0.518372200 |
| 24 | 0.513891811 | 0.977733112 | 0.502449040 |
| 25 | 0.498573856 | 0.976816163 | 0.487015001 |
| 26 | 0.483712495 | 0.975900073 | 0.472055059 |
| Total | | | 16.59993604 |

TABLE F
Sample Rate Calculation
State of New York

| | | |
|---|---|---|
| 1. | Annual Salary of Applicant | $80,000 |
| 2. | State of Residence | New York |
| 3. | Industry | Education |
| | | and Health |
| | | Services |
| 4. | State maximum weekly benefit (lookup) | 405.00 |
| 5. | Industry Factor | .639 |
| 6. | State incidence rate (lookup) | .05831 |
| 7. | State annuity factor (lookup) | 16.599936 |
| 8. | Weekly maximum benefit (=50% of 1. | 769.23 |
| | divided by 52) | |
| 9. | Weekly insured benefit (=8. minus 4.) | 364.23 |
| 10. | Annual claim cost (=9. * 5. * 6. * 7.) | 225.28 |
| 11. | Monthly premium without waiver (=10./12/.49) | 38.31 |
| 12. | State waiver factor (lookup) | .0380 |
| 13. | Waiver multiplier (=1/(1 − (12. * 5.)) | 1.0249 |
| 14. | Final Rate (=11. * 13.) | 39.30 |

Additional Uses

There are a number of foreseeable uses or adaptations of the system and methods above-discussed, besides that of providing strictly personal, individual PUI.

According to one variation, a personal financial services product may be provided as part of a portfolio of investments and annuities. Currently, financial services firms generally advise clients on smoothing their cash flow for foreseeable life events where income diminishes, like retirement; or where expenses increase, like for children's college funds. However, smoothing short term income shortfalls is generally not possible, though it should be a key aspect of a stable portfolio. There exist products for some completely unforeseeable catastrophic events such as disability or loss of business continuity. PUI will provide added financial security protecting a middle or high income individual for this somewhat expectable calamity.

With some small modifications, this product can be used as a tradable derivative, to allow sophisticated investors to invest, speculate or hedge on the future probability in unemployment, including unemployment in particular industries, occupations, and geographic locations such as states.

Having thus presented underlying concepts of the methods and systems in connection with which some implementations have been discussed by way of example only, it will now be understood that various other embodiments and uses will occur to those skilled in the art, all of which are intended to be within the spirit and scope of the invention. The claims define various aspects of the invention and it will be further understood that not all aspects of the invention are necessarily practiced in a given instance. An embodiment may practice one or more aspects of the invention. Accordingly, the examples shown are for purposes of illustration and not limitation, the invention being limited only as required in the appended claims.

What is claimed is:

1. A method of providing supplemental unemployment insurance comprising:
a. issuing to an applicant an insurance policy which, in exchange for premium payments entitled the applicant, when unemployed, to receive a periodic financial benefit for a specified time, provided a state government agency responsible for the administration of unemployment claims verifies the applicant is entitled to receive unemployment insurance benefits from the state;
b. upon receiving from the applicant a claim for unemployment benefits, obtaining from the state government agency confirmation that the applicant is entitled to receive unemployment insurance benefits from the state; and
c. paying to the applicant the financial benefit specified according to the policy.

2. The method of claim 1, wherein obtaining from the state government agency said confirmation is performed by a computer system querying a computer system or database of the state agency, receiving a response to said query, and evaluating said response; and paying the applicant is conditioned on the evaluation of the response indicating the applicant is entitled to a financial benefit.

3. The method of claim 1 or claim 2 wherein the financial benefit is set in the policy to a predetermined portion of the applicant's income when employed, just prior to becoming unemployed, less said applicant's state unemployment insurance benefit.

4. The method of claim 3 wherein issuing to an applicant an insurance policy comprises:
d. via a computer system, receiving from the applicant answers to questions about risk factors used in computing the applicant's eligibility for said supplemental unemployment insurance and, if eligible, an amount of potential financial benefit and a premium therefor;
e. computing said premium if the applicant is eligible;
f. offering to the applicant a policy specifying a potential financial benefit in the event a claim is submitted, unemployment and eligibility for payment are confirmed and premium payments are current; and
g. issuing the policy if the offer is accepted and an initial premium payment is received.
